(19) United States
(12) Patent Application Publication
(10) Pub. No.: US 2026/0243410 A1
(43) Pub. Date: Aug. 20, 2026

(54) LUMINAIRE ASSEMBLY

(71) Applicant: SIGNIFY HOLDING B.V., EINDHOVEN (NL)

(72) Inventor: CHRISTOPHER ANDREW VOELKER, LEXINGTON, KY (US)

(21) Appl. No.: 19/474,742

(22) PCT Filed: Apr. 8, 2024
(86) PCT No.: PCT/EP2024/059427

§ 371 Date: Oct. 13, 2025

Related U.S. Application Data
(60) Provisional application No. 63/458,810, filed on Apr. 12, 2023.

(30) Foreign Application Priority Data
Apr. 24, 2023 (EP) 23169371.4

(51) Int. Cl. F21V 17/16; F21V 15/015; F21V 17/12; F21V 23/00; F21Y 103/10; F21Y 115/10

(52) U.S. Cl. CPC F21V 17/164; F21V 15/015; F21V 17/12; F21V 23/009; F21Y 2103/10; F21Y 2115/10

(57) ABSTRACT

A luminaire assembly including a channel device and a platform device is provided. The channel device has a central channel portion and two integrated end plates. The central channel portion extends between a first and second end. The integrated end plates meet the central channel portion at bendable edges at the first and second ends, respectively. The integrated end plates pivot about the bendable edges. The integrated end plates each include a return flange. The platform device includes an aperture, mating return flanges, and a first and a second platform portion. The aperture receives the central channel portion of the channel device. The mating return flanges engage the return flanges of the integrated end plates to secure the channel device to the platform device. The first and second platform portions are located on opposing sides of the channel device when the channel device is secured to the platform device.

### FIELD OF THE DISCLOSURE

The present disclosure is generally directed to a luminaire assembly, and more specifically, to a compact luminaire assembly optimally designed for rapid and/or automated manufacturing.

### BACKGROUND

Many conventional light emitting diode (LED) luminaire assemblies are comprised of many subcomponents and complicated mechanical assemblies. For instance, certain existing low bay and high bay LED-based conventional luminaire assemblies typically include a cuboid-shaped, centrally located electrical enclosure for electrical components (wire splices, LED drivers, etc.) and a pair of heat sinks. For instance, the electrical enclosure typically includes four components: (a) a channel with a 3-side rectangular or otherwise u-shaped profile, typically stamped sheet metal or extruded aluminum; (b) a predominantly flat, removable “channel cover” serving as the fourth side of the channel profile while facilitating access to the electrical components enclosed within during luminaire installation, maintenance, etc., also typically stamped sheet metal or extruded aluminum; and (c) two “end plates” attached to each open end of the channel, serving as the final two sides of the cuboid. The width of the end plates is typically longer than the width of the channel profile. In other words, when viewed from above or below, the overall shape of the electrical enclosure resembles a capital letter ‘I,’ with the single central vertical lines corresponding to the channel, and the horizontal lines corresponding to the end plates. The two heat sinks typically span the gap between each end plate on either side of the electrical enclosure. LED light sources are then attached to the underside of each heat sink. The heat sinks are also typically stamped sheet metal or extruded aluminum. In such existing designs, the principal components are assembled together using numerous mechanical fasteners, resulting in a time-consuming, labor-intensive assembly process. Accordingly, there is a need in the art for a luminaire assembly for rapid and/or automated manufacturing to reduce assembly time, labor costs, and/or manufacturing overhead.

### SUMMARY OF THE DISCLOSURE

The present disclosure is generally directed to a luminaire assembly having a compact and easy-to-assemble design with a reduced part number count as compared to conventional designs. These improvements are primarily achieved by incorporating hinged end plates into a monolithic channel device and replacing the pair of heat sinks with a single platform device. The hinged end plates facilitate coupling the channel device to the single platform device. This design and reduced part count greatly simplifies the assembly process and will reduce labor time and cost during manufacturing.

Generally, the luminaire assembly includes at least a channel device, a platform device, and a channel cover. The channel device is defined by a central channel portion configured to hold driver(s) and other electrical components. A pair of integrated end plates are arranged at bendable edges of the channel portion such that the integrated end plates may pivot within a range of approximately 45 degrees. In some examples, the bendable edges are scored to allow the integrated end plates to pivot or swing. The integrated end plates each include a return flange to facilitate coupling with the platform device. In some examples, the return flange of the channel device includes a return hook to catch on to aspects of the platform device. Preferably, the channel device is an aluminum or sheet metal monolithic structure.

The platform device is defined by first and second platform portions forming an aperture shaped to receive the central channel portion of the channel device. Light sources, such as a plurality of light-emitting diodes (LEDs), may be mounted to one or both of the first and second platform portions. These light sources are electrically connected to the driver circuits arranged within the central channel portion of the channel device. The platform device further includes a plurality of mating return flanges configured to engage with the return flanges of the integrated end plates when the integrated end plates of the channel device are pivoted towards the platform device, thus securing the channel device to the platform device. Preferably, the platform device is also an aluminum or sheet metal monolithic structure.

Once the platform device is secured to the channel device, a channel cover may be coupled to the channel device and the platform device via one or more fasteners to protect the driver circuits and the other components arranged within the channel device. Further, one or more flexible lenses may be installed in the luminaire assembly to refract light generated by the light sources. Each flexible lens may be installed by bending or buckling the lens and inserting each end of the lens into one of the integrated end plates. In particular, the ends of each of the flexible lenses may be secured in place by the return flanges of the integrated end plates and a lip of the channel cover.

Generally, in one aspect, a luminaire assembly is provided. The luminaire assembly includes a channel device. The channel device has a central channel portion. The central channel portion extends between a first end and a second end. The channel device further includes a pair of integrated end plates. The integrated end plates meet the central channel portion at bendable edges at the first end and second end of the central channel portion, respectively. The integrated end plates are configured to pivot about the bendable edges. Each of the integrated end plates includes a return flange. According to an example, at least one of the bendable edges is scored. According to a further example, the bendable edges may be configured to enable the integrated end plates to pivot within a range of approximately 45 degrees.

The luminaire assembly further includes a platform device. The platform device includes an aperture. The aperture is configured to receive the central channel portion of the channel device. The platform device further includes mating return flanges. The mating return flanges are configured to engage the return flanges of the integrated end plates to secure the channel device to the platform device. The platform device further includes a first platform portion and a second platform portion. The first and second platform portions are located on opposing sides of the channel device when the channel device is secured to the platform device.

According to an example, the return flange of each of the integrated end plates includes an end hook configured to catch the mating return flanges.

According to an example, the luminaire assembly further includes a channel cover. The channel cover is configured to be coupled to the channel device and the platform device via one or more fasteners.

According to an example, the luminaire assembly includes one or more flexible lenses configured to be received by the integrated end plates. The one or more flexible lenses may be configured to be secured to the luminaire assembly via the return flange of the integrated end plates and a lip of a channel cover.

According to an example, the channel device and/or the platform device are monolithic structures. The channel device and the platform device may be substantially aluminum.

According to an example, the luminaire assembly may further include a plurality of light sources. The plurality of light sources is mounted to the platform device.

According to an example, the luminaire assembly may further include a driver. The driver is mounted to the central channel portion of the channel device.

Generally, in another aspect, a method for manufacturing a luminaire assembly is provided. The method includes inserting a central channel portion of a channel device into an aperture of a platform device. The platform device includes a first platform portion and a second platform portion. The first and second platform portions are located on opposing sides of the channel device when the central channel portion is inserted into the aperture.

The method further includes pivoting a pair of integrated end plates of the channel device about bendable edges of the channel device such that a return flange of each of the integrated end plates engages with mating return flanges of the platform device such that the channel device is secured to the platform device.

According to an example, the method may further include coupling a channel cover to the channel device and the platform device via one or more fasteners.

According to an example, the method may further include mounting a plurality of light sources to the platform device. Further to this example, the method may further include mounting a driver to the central channel portion of the channel device.

According to an example, the method may further include securing one or more flexible lenses to the luminaire assembly via the return flange of the integrated end plates.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an isometric view of a luminaire assembly having a channel device and a platform device, according to aspects of the present disclosure.

FIG. 2 is another isometric view of the luminaire assembly of FIG. 1, according to aspects of the present disclosure.

FIG. 3 is an isometric view of the luminaire assembly of FIGS. 1 and 2 with the pair of flexible lenses removed to expose a plurality of light sources, according to aspects of the present disclosure.

FIG. 4 is an isometric view of a channel device, according to aspects of the present disclosure.

FIG. 5 is another isometric view of the channel device of FIG. 4, according to aspects of the present disclosure.

FIG. 6 is an isometric view of a channel device having a pair of end caps swung out about a corresponding pair of bendable edges, according to aspects of the present disclosure.

FIG. 7 is a side view of a channel device of FIG. 6, according to aspects of the present disclosure.

FIG. 8 is an isometric view of an integrated end plate of a channel device, according to aspects of the present disclosure.

FIG. 9 is an isometric view of a platform device, according to aspects of the present disclosure.

FIG. 10 is another isometric view of the platform device of FIG. 9, according to aspects of the present disclosure.

FIG. 11 is a side view of a mating return flange of a platform device, according to aspects of the present disclosure.

FIG. 12 is a side view of a return flange of a channel device engaged with a mating return flange of a platform device, according to aspects of the present disclosure.

FIG. 13 is another side view of the return flange of the channel device engaged with the mating return flange of the platform device, according to aspects of the present disclosure.

FIG. 14 is an isometric view of a luminaire assembly showing a plurality of light sources mounted on a platform device, according to aspects of the present disclosure.

FIG. 15 is a top view of a luminaire assembly showing a light-emitting diode (LED) driver mounted on a channel device, according to aspects of the present disclosure.

FIG. 16 is a top view of a luminaire assembly showing a pair of flexible lenses installed on the platform device, according to aspects of the present disclosure.

FIG. 17 is a top view of a luminaire assembly showing a channel cover installed via a pair of fasteners, according to aspects of the present disclosure.

FIG. 18 is an isometric view of a luminaire assembly showing a flexible lens installed on the platform device, according to aspects of the present disclosure.

FIG. 19 is an exploded view of a luminaire assembly, according to aspects of the present disclosure.

FIG. 20 is a flowchart of a method for manufacturing a luminaire assembly, according to aspects of the present disclosure.

### DETAILED DESCRIPTION OF EMBODIMENTS

The present disclosure is generally directed to a luminaire assembly having a compact and easy-to-assemble design with a reduced part number count as compared to conventional designs. These improvements are primarily achieved by incorporating hinged end plates into a monolithic channel device and replacing the pair of heat sinks with a single platform device. The hinged end plates facilitate coupling the channel device to the single platform device. This design and reduced part count greatly simplifies the assembly process and will reduce labor time and cost during manufacturing.

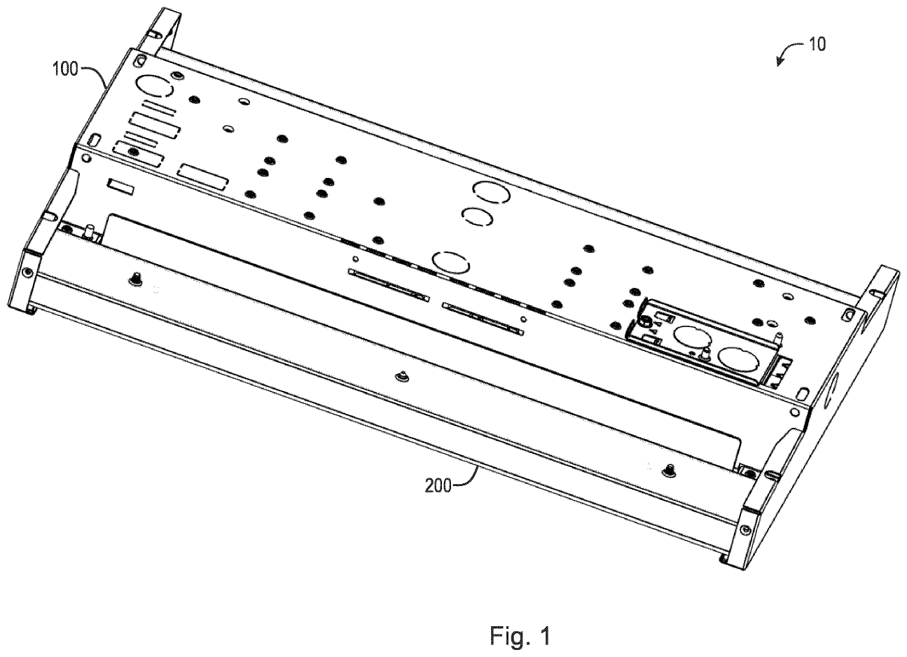

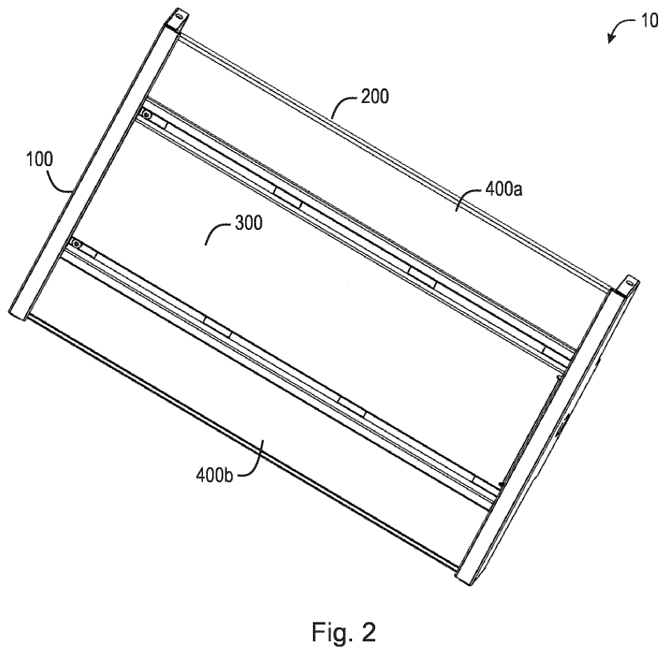

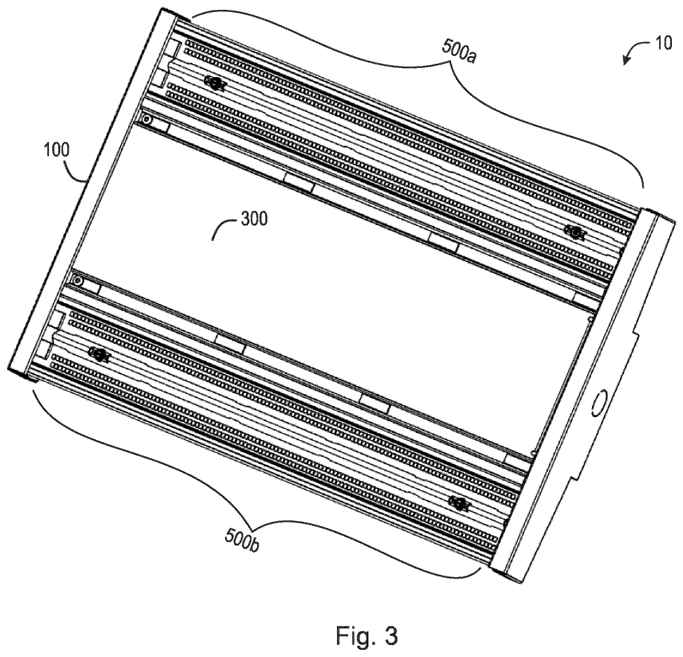

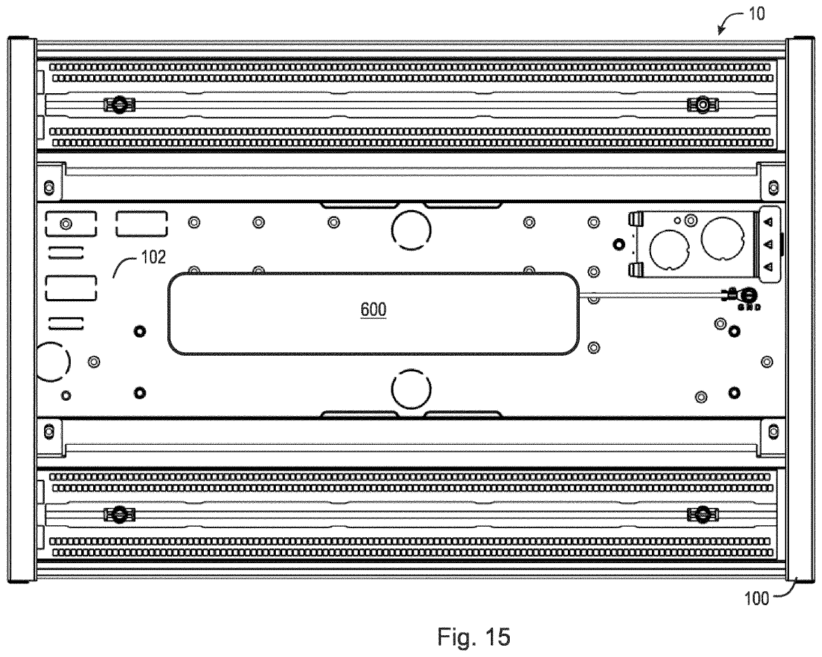

FIGS. 1 and 2 are isometric views of a non-limiting example of a luminaire assembly 10. Broadly, the luminaire assembly 10 includes a channel device 100, and a platform device 200, a channel cover 300, a pair of flexible lenses 400a, b, a plurality of light sources 500a, b (see FIG. 3) and a driver (or driver circuit) 600 (see FIG. 15), among other components. As will be demonstrated in reference to subsequent figures, the channel device 100 couples to the platform device 200 by (1) inserting a central channel portion 102 into an aperture 202 of the platform device 200 and (2) pivoting or swinging a pair of integrated end plates 108a, b about bendable edges 110a, b of the channel device 100 such that a return flange 112a, b of each integrated end plate 108a, b engages with a respective mating return flange 204a1-3, b1-3 of the platform device, thereby securing the channel device 100 to the platform device 200. Further, the plurality of light sources 500a, b is mounted on the platform device 200, and a driver circuit 600 is mounted within the channel device 100. A pair of flexible lenses 400a, b are then installed by slightly buckling each lens 400a, b and inserting the ends of each lens 400a, b into a corresponding integrated end plate 108a, b such that the installed lenses 400a, b cover the mounted light sources 500a, b, respectively. A channel cover 300 is then coupled to the channel device 100 and the platform device 200 to cover the central channel portion 102.

FIG. 3 is an isometric view of the luminaire assembly 10 of FIGS. 1 and 2 with the pair of flexible lenses 400a, b removed to expose a first and second plurality of light sources 500a, b mounted to the platform device 200. As shown in FIG. 3, the plurality of light sources 500a, b may be one or more rows of light-emitting diodes (LEDs).

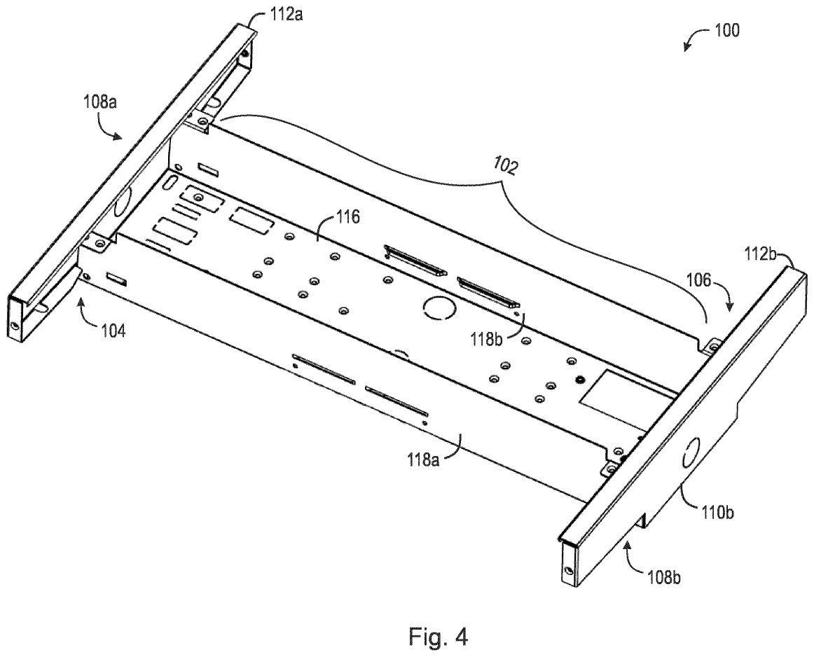

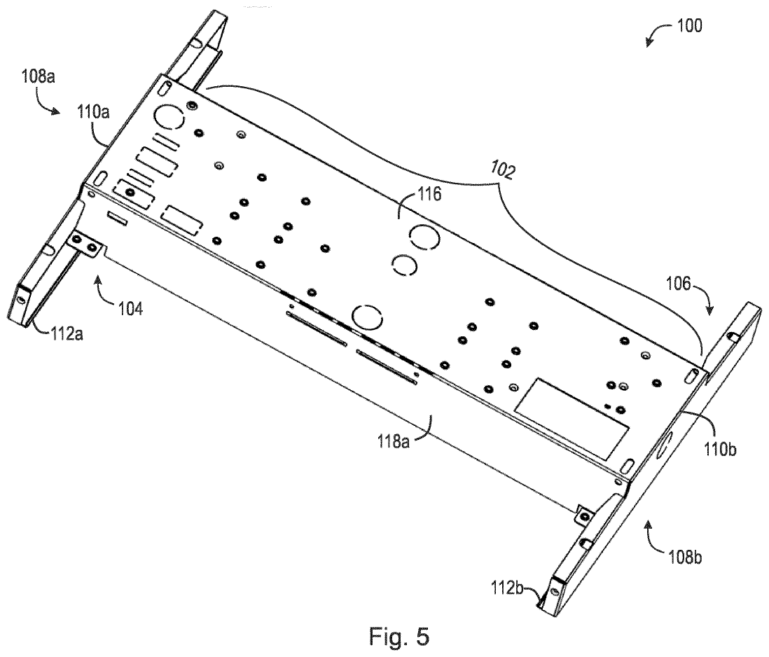

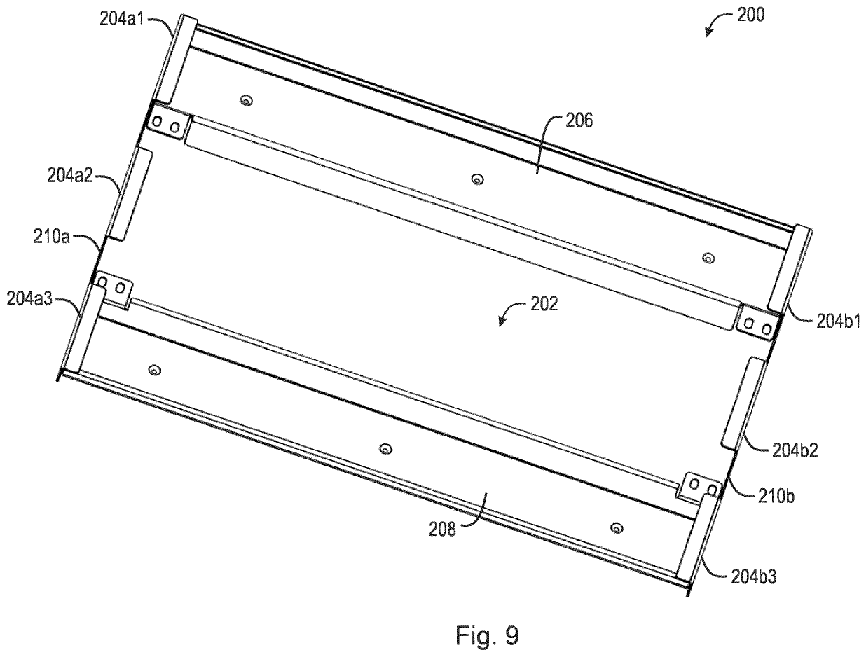

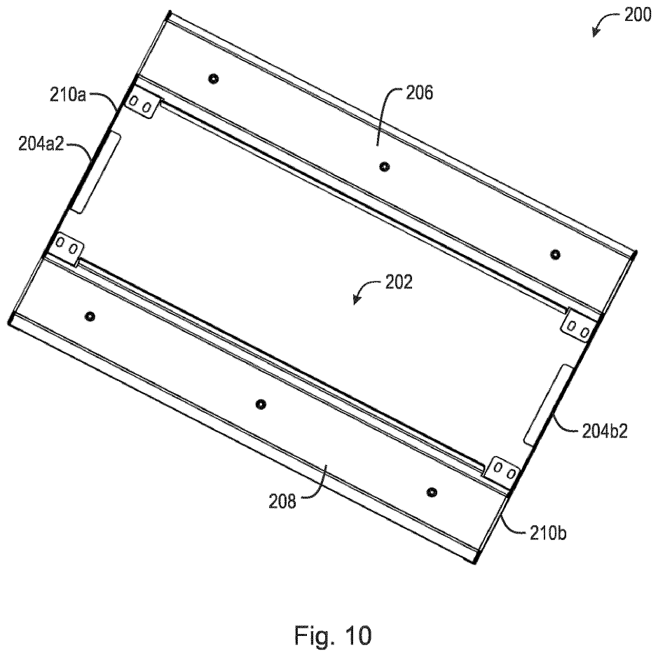

FIGS. 4 and 5 are isometric views of a non-limiting example of the channel device 100. The channel device 100 is defined by the central channel portion 102 extending between a first end 104 and a second end 106. Generally, the central channel portion 102 is shaped to fit within an aperture 202 of a platform device 200 (see FIGS. 9 and 10). As shown in FIGS. 4 and 5, the central channel portion 102 may be defined by a horizontal side 116 and a pair of vertical sides 118a, b meeting the horizontal side 116 at angles of approximately ninety degrees. Accordingly, the overall shape of the central channel portion 102 may be a substantially rectangular cuboid structure with an open bottom side such that one or more components of the luminaire assembly 10 (such as a driver circuit 600) may be mounted within the central channel portion 102. In other examples, the central channel portion 102 may be configured into other shapes depending on the desired application.

The channel device 100 includes a pair of integrated end plates 108a, b. In the example of FIGS. 4 and 5, the integrated end plates 108a,b are arranged at opposite ends 104, 106 of the central channel portion 102. For example, a first integrated end plate 108a is arranged proximate to the first end 104, while a second integrated end plate 108b is arranged proximate to the second end 106. Each integrated end plate 108a, b meets the central channel portion 102 at a bendable edge 110a, b. As will be demonstrated with respect to subsequent figures, the bendable edges 110a, b enable the integrated end plates 108a, b to pivot or swing relative to the central channel portion 102. In some examples, the bendable edges 110a, b are scored or otherwise modified or treated to allow the integrated end plates 108a, b to pivot or swing. In some examples, one or both of the integrated end plates 108a, b may pivot within a range of approximately 45 degrees relative to an edge of the vertical walls 118a, b of the central channel 102.

Further, each of the integrated end plates 108a, b is further configured to be mechanically coupled to the platform device 200. As shown in FIGS. 4 and 5, each of the integrated end plates 108a, b includes a mating flange 112a, b. The mating flanges 112a, b are configured to engage mating return flanges 204a1-3, b1-3 of the platform device 100, thereby securing the channel device 100 to the platform device 200 without additional parts. Preferably, the channel device 100 is a monolithic structure manufactured of aluminum, sheet metal, or a similar material.

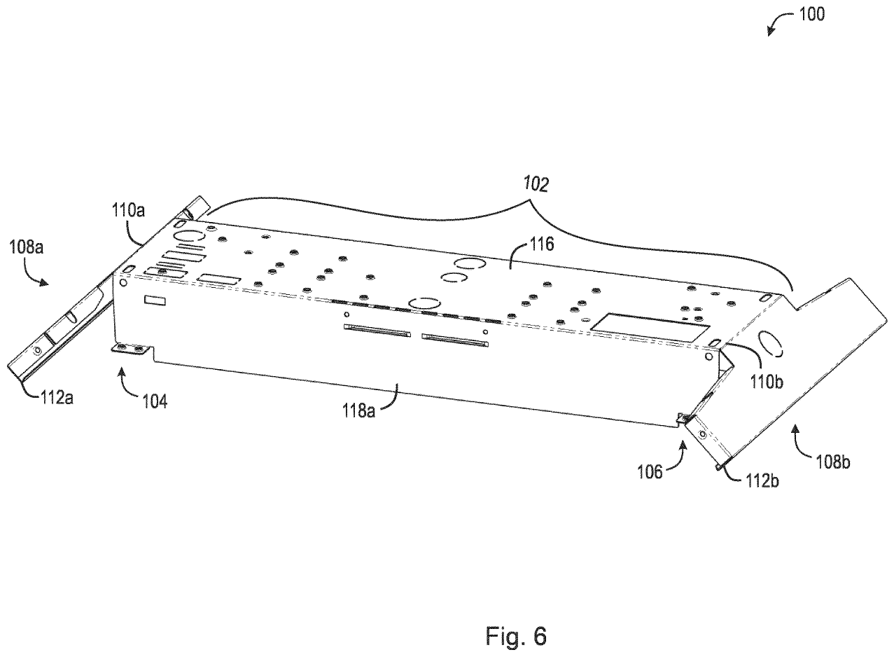

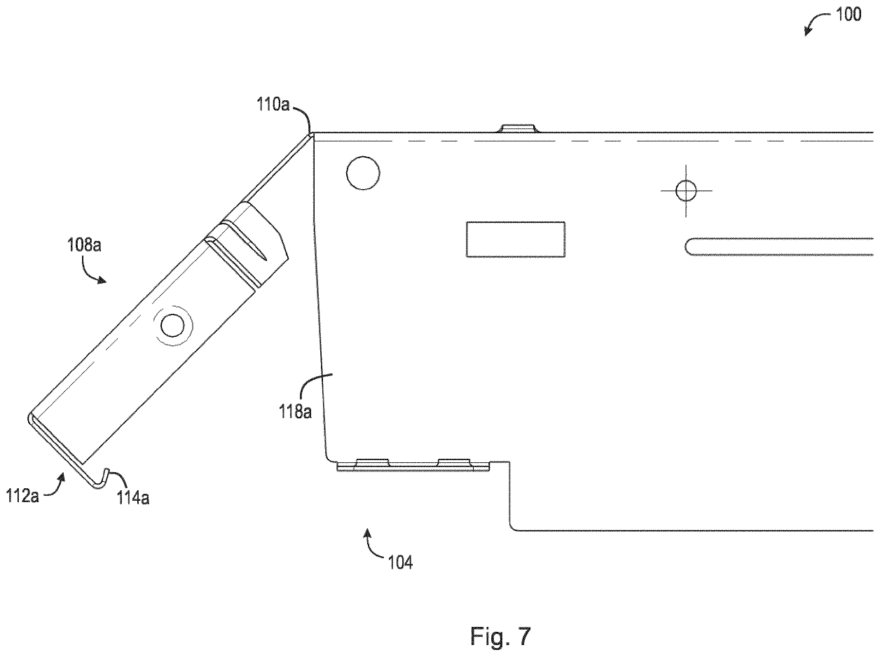

FIG. 6 is an isometric view of the channel device 100. In FIG. 6, the integrated end plates 108a, b of the channel device 100 are pivoted about the bendable edges 110a, b at an angle of approximately 45 degrees. In some examples, the pivoting range of one of the integrated end plates 108a, b may be greater than or less than 45 degrees. FIG. 7 is a more detailed side view of the channel device of FIG. 6, showing the first integrated end plate 108a at an angle of approximately 45 degrees relative to an edge of the vertical walls 118a of the central channel portion 102.

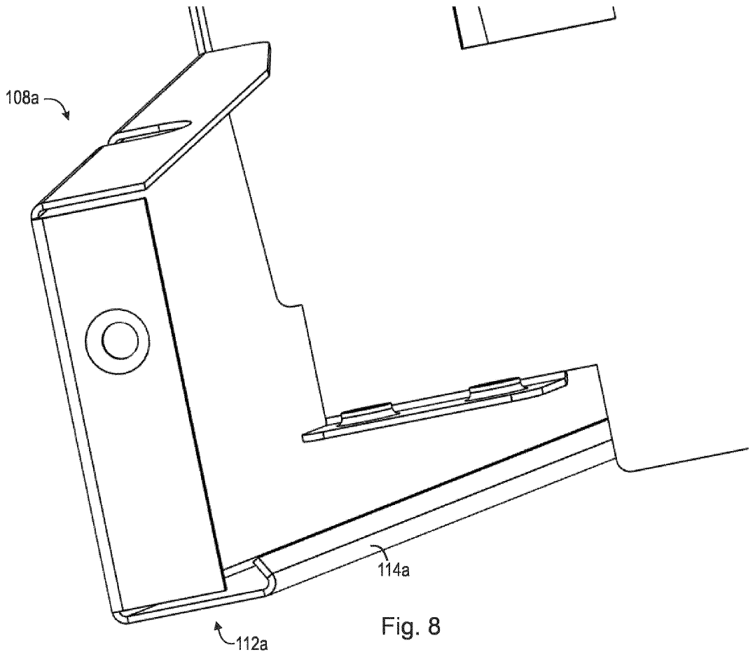

FIG. 7 further shows an example return flange 112a of the first integrated end plate 108a as including an end hook 114a. Although return flange 112a is illustrated and described in further detail, it is to be understood that return flange 112b may include the same features. The end hook 114a is configured to catch mating return flanges 204a1-a3 of the platform device 200, thereby securing the first integrated end plate 108a (and therefore the channel device 100) to the platform device 200. FIG. 8 shows an isometric view of the first integrated end plate 108a, return flange 112a, and end hook 114a of FIG. 7.

FIGS. 9 and 10 are isometric views of a non-limiting example of a platform device 200. Broadly, the platform device 200 is defined by a first platform portion 206 and a second platform portion 208. As shown in FIGS. 9 and 10, the platform portions 206, 208 are substantially rectangular, though the platform portions 206, 208 may be other shapes or configurations as required by the desired application of the luminaire assembly 10. Further the platform portions 206, 208 are typically configured for the installation of a plurality of light sources 500a, b, respectively, as well as other components within the platform portions 206, 208. For example, and as previously shown in FIG. 3, the first plurality of light sources 500a may be mounted onto the first platform portion 206, while the second plurality of light sources 500b may be mounted onto the second platform portion 208.

The platform portions 206, 208 are coupled to each other via a pair of horizontal members 210a, b. In the non-limiting example of FIGS. 9 and 10, the platform portions 206, 208 are significantly longer than the horizontal members 210a, b. The combination of the platform portions 206, 208 and the horizontal members 210a, b forms the aperture 202 within the platform device 200. During manufacturing of the luminaire assembly 10, the central channel portion 102 of the channel device 100 is inserted into the aperture 202. While the aperture 202 of FIGS. 9 and 10 is substantially rectangular, the aperture 202 may be other shapes or configurations as required to receive the central channel portion 102.

The platform device 200 further includes mating return flanges 204a1-a3, b1-b3. The example of FIGS. 9 and 10 show three mating return flanges 204a1-3 arranged along the first horizontal member 210a and three more mating return flanges 204b1-3 arranged along the second horizontal member 210b. In other examples, the mating return flanges 204a1-a3, b1-b3 may be embodied as a single mating return flange on each horizontal member 210a, b. In these other examples, the single mating return flanges 204a, b may run along the entirety (or most of the entirety) of the length of the horizontal members 210a, b.

The mating return flanges 204a1-a3, b1-3 are configured to engage the return flanges 112a, b, respectively, of the channel device 100, thereby securing the platform device 200 to the channel device 100. Preferably, the platform device 200 is a monolithic structure manufactured of aluminum, sheet metal, or a similar material.

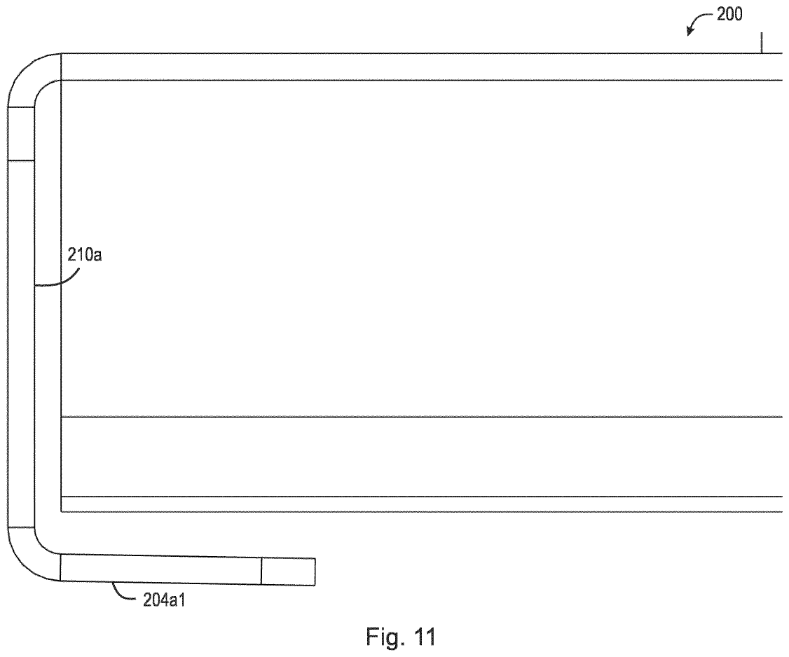

FIG. 11 shows a more detailed side view of a portion of the platform device 200. In FIG. 11, the first mating return flange 204a1 is arranged along the first horizontal member 210a of the platform device 200. Although not shown in FIG. 11, it is to be understood that mating return flanges 204a2, a3 are arranged along the first horizontal member 210a in a similar manner. It is further to be understood that the mating return flanges 204b1-b3 are arranged on horizontal member 210b in a similar fashion. As shown in FIG. 11, the angle formed between the first mating return flange 204a1 and the first horizontal member 210a may be slightly greater than 90 degrees, such as between 91 and 100 degrees.

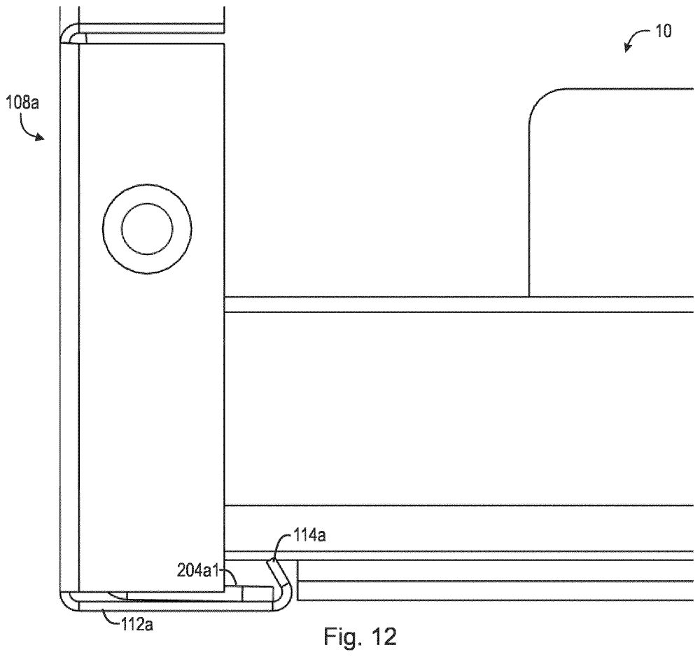

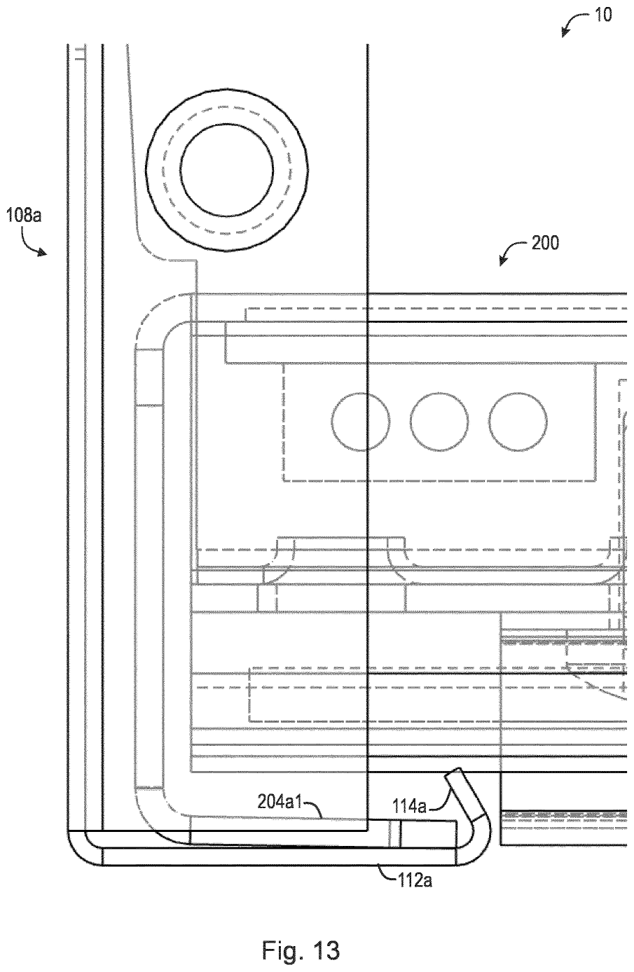

The configurations of the aforementioned channel device 100 and platform device 200 enable easy assembly of the luminaire assembly 10 in two simple steps. First, the central channel portion 102 of the channel device 100 is inserted into the aperture 202 of the platform device 100. Due to this insertion, the first and second platform portions 206, 208 of the platform device 200 are arranged on opposing sides of the central channel portion 102 of the channel device 100. Further, the insertion also aligns the integrated end plates 108a, b of the channel device 100 with the horizontal members 210a, b of the platform device 100. Due to this alignment, the return flanges 112a, b of each of the integrated end plates 108a, b may engage with the corresponding mating return flanges 204a1-a3, b1-b3 of the platform device 200 by pivoting or swinging the integrated end plates 108a, b about the bendable edges 110a, b of the channel device 100 towards the platform device 200. This engagement may be enabled by catching the end hooks 114a, b of the return flanges 112a, b on the mating return flanges 204a1-a3, b1-b3, thereby securing the channel device 100 to the platform device 200. The result of these assembly steps is shown in FIGS. 12 and 13. FIG. 12 is a side view of the first return flange 112a of the channel device 100 engaged with the first mating return flange 204a of the platform device 200. FIG. 13 is another side view of the same configuration as FIG. 12 only with the components hidden behind the first integrated end cap 108a made visible. FIGS. 12 and 13 demonstrate the end hook 114a of the first return flange 112a of the channel device 100 catching the first mating return flange 204a1 of the platform device 100. Similarly, the remaining mating return flanges 204a2, a3, b1-b3 also engage with their corresponding return flange 112a, b to secure the channel device 100 to the platform device 200.

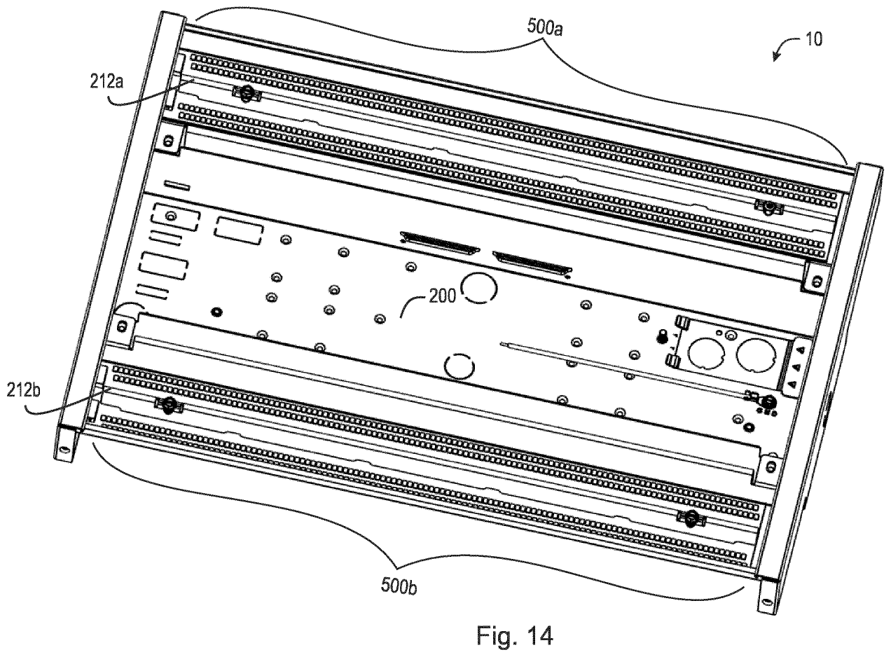

FIG. 14 is an isometric view of a luminaire assembly 10 showing the plurality of light sources 500a, b mounted on the platform device 200. Following the mechanical coupling of the channel device 100 to the platform 200, the next step to assemble the luminaire assembly 10 involves mounting the plurality of light sources 500a, b to the platform device 200. As shown in FIG. 14, the first plurality of light sources 500a (embodied as four rows of LEDs) are mounted in the first platform portion 206 of the platform device 200, while the second plurality of light sources 500b (also embodied as four rows of LEDs) are mounted in the second platform portion 208. Further, an optional reflector 212a, b is also mounted in each platform portion 206, 208 to direct and/or enhance the light provided by the luminaire assembly 10.

FIG. 15 is a top view of a luminaire assembly 10 showing the LED driver circuit 600 mounted on the channel device 100. Following the mounting of the plurality of light sources 500a, b and the reflectors 212a, b within the platform portions 206, 208 of the platform device 200, the next assembly step includes mounting the LED driver circuit 600 and other circuitry, components, and wiring to the central channel portion 102 of the channel device 100. This wiring may be used to electrically couple the driver circuit 600 and components within the central channel portion 102 to the plurality of light sources 500a, b.

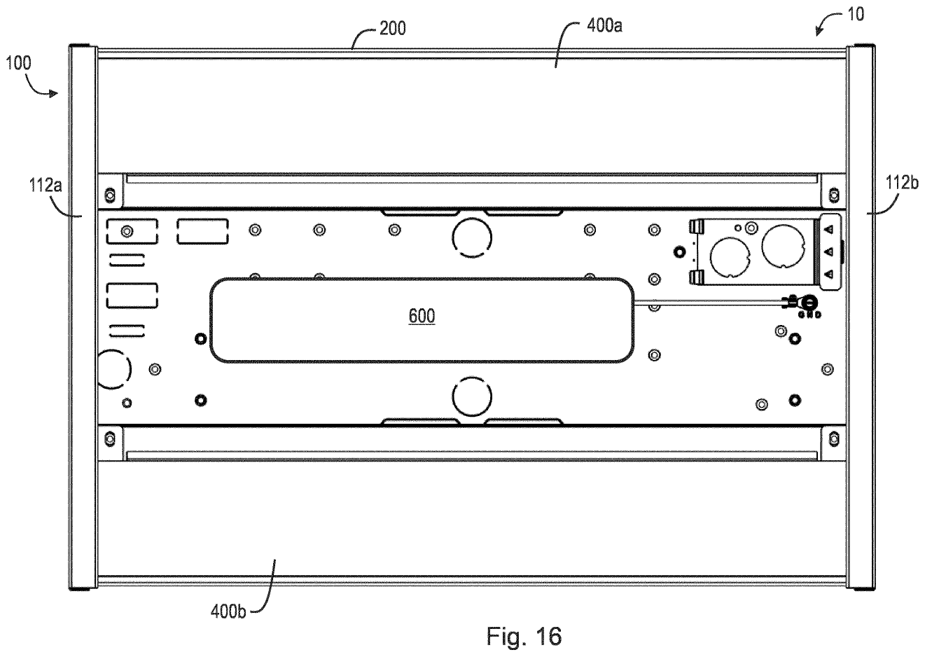

FIG. 16 is a top view of a luminaire assembly 10 showing the pair of flexible lenses 400a, b installed on the platform device 200. As shown in FIG. 16, the first flexible lens 400a is arranged over the first platform portion 206, while the second flexible lens 400b is arranged over the second platform portion 208. The flexible lenses 400a, b are preferably made of a flexible plastic or other flexible, translucent or transparent material. As can be seen in FIG. 16, the flexible lenses 400a,b are slightly longer than a distance between the return flanges 112a, b of the integrated end plates 108a, b of the channel device 100. The flexible lenses 400a, b are received by the integrated end plates 108a, b by buckling the flexible lenses 400a, b and sliding the ends of the flexible lenses 400a, b underneath the return flanges 112a, b. Thus, in a relaxed state, the ends of the flexible lenses 400a, b will be arranged within the integrated end plates 108a, b.

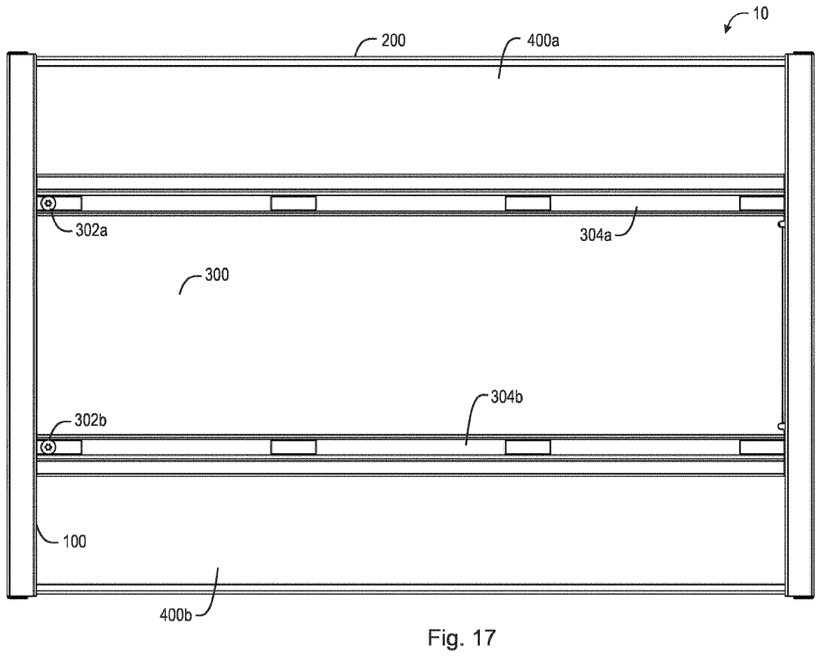

FIG. 17 is an isometric view of a luminaire assembly 100 showing the channel cover 300 installed via a pair of fasteners 302a, b. The channel cover 300 is positioned over the open bottom side of the central channel portion 102 of the channel device 100 to protect the LED driver circuit 600 and the other components arranged within. In the non-limiting example shown in FIG. 17, the channel cover 300 is coupled to both the channel device 100 and the platform device 200.

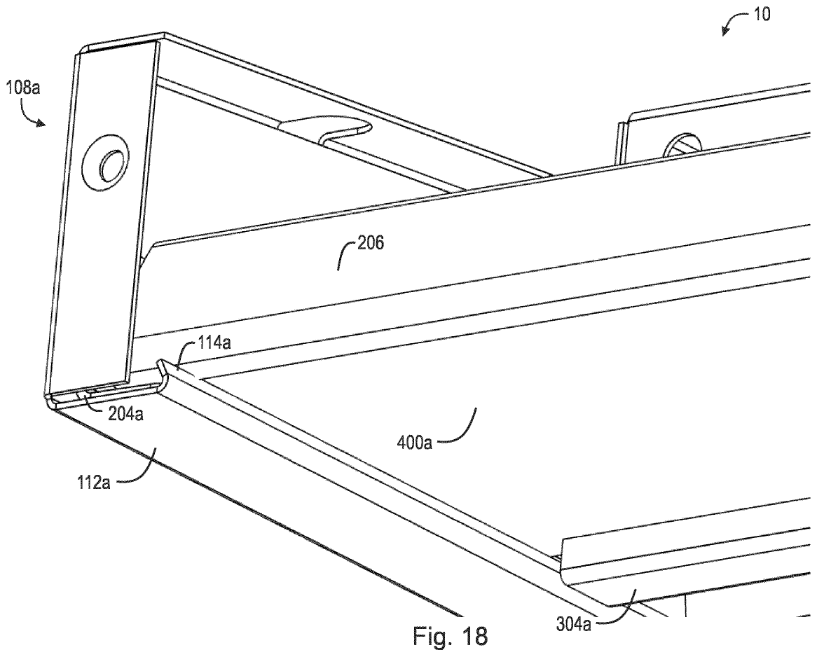

Further, the channel cover 300 includes two lips 304a, b. Upon installation of the channel cover 300, the two lips 304a, b overlap longitudinal edges of the flexible lenses 400a, b. This arrangement is shown in more detail in the isometric view of FIG. 18. Thus, the flexible lenses 400a, b are secured to the luminaire assembly 10 by both the return flanges 112a, b of the integrated end plates 108a, b of the channel device 100 and the lips 304a, b of the channel cover 300.

Preferably, the channel cover 300 may be aluminum, sheet metal, or a similar material. The fasteners 302a, b may be screws, bolts, or any other type of fastener. While the non-limiting example of FIG. 17 illustrates two fasteners 302a,b coupling the channel cover 300 to the channel device 100 and the platform device, any practical number of fasteners 302 may be used.

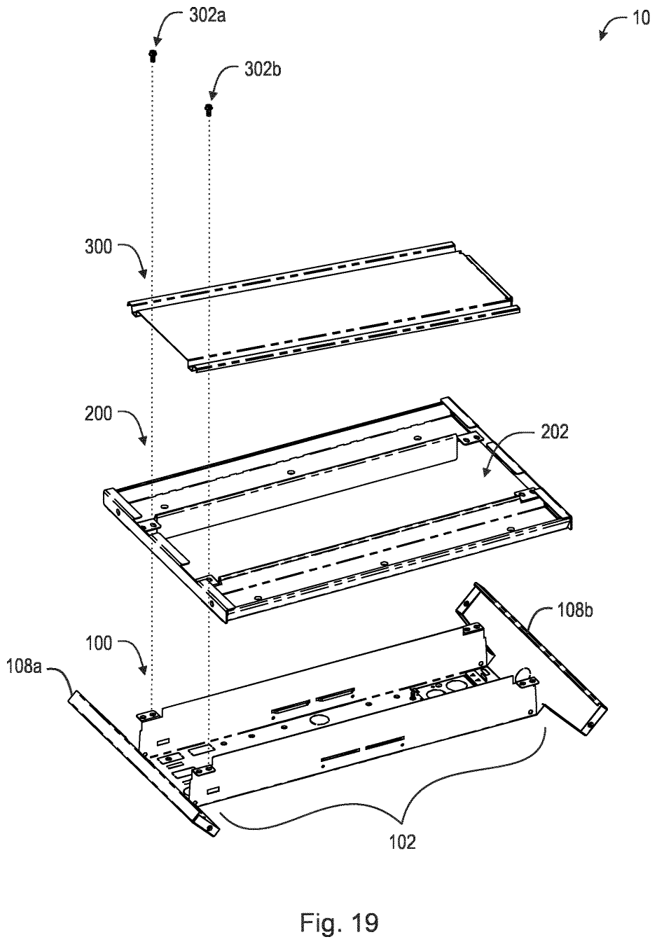

FIG. 19 is an exploded view of the luminaire assembly 10 shown in the previous figures. The luminaire assembly of FIG. 19 has a channel device 100, a platform device 200, a channel cover 300, and two fasteners 302a, b (such as screws, bolts, or any other type of fastener). In particular, FIG. 19 demonstrates the ease of assembling the luminaire assembly 10. As previously described, the luminaire assembly 10 is assembled by inserting the central channel portion 102 into the aperture 202 of the platform device 200.

The pair of integrated end plates 108a, b of the channel device 100 are then pivoted to couple to the platform device 100, thereby securing the channel device 100 to the platform device 200. The channel cover 300 is then coupled to the channel device 100 and the platform device 200 via the fasteners 302a, b to, in part, protect components arranged within the central channel portion 102.

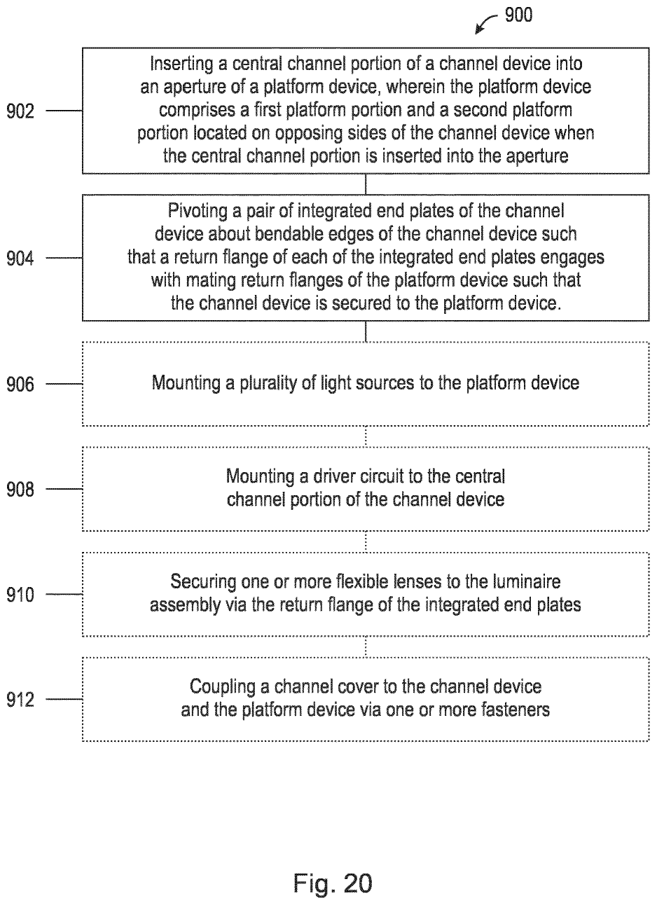

FIG. 20 is a flowchart of a method 900 for manufacturing a luminaire assembly, such as the luminaire assembly 10 shown in FIGS. 1, 2, and 17, by way of example. Referring to FIGS. 1-20, the method 900 includes, in step 902, inserting the central channel portion 102 of the channel device 100 into the aperture 202 of the platform device 200. The platform device 200 includes the first platform portion 206 and the second platform portion 208. The first and second platform portions 206, 208 are located on opposing sides of the channel device 100 when the central channel portion 102 is inserted into the aperture 202. The method 900 further includes, in step 904, pivoting the pair of integrated end plates 108a, b of the channel device 102 about bendable edges 110a, b of the channel device 102 such that the return flange 112a, b of each of the integrated end plates 108a, b engages with mating return flanges 204a1-3, b1-3 of the platform device 200 such that the channel device 100 is secured to the platform device 200.

According to a further non-limiting example, the method 900 may further include, in step 906, mounting the plurality of light sources 500a, b to the platform device 200. Further to this example, the method 900 may further include, in step 908, mounting the driver circuit 600 to the central channel portion 102 of the channel device 100.

According to a further non-limiting example, the method 900 may further include, in step 910, securing one or more flexible lenses 400a, b to the luminaire assembly 10 via the return flange 112a, b of the integrated end plates 108a, b.

According to a non-limiting example, the method 900 may further include, in step 912, coupling the channel cover 300 to the channel device 100 and the platform device 200 via one or more fasteners 302a, b. By coupling the channel cover 300 to the channel device 100 and the platform device 200, the lips 304a, b of the channel cover 300 further secure the one or more flexible lenses 400a, b to the luminaire assembly 10.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A luminaire assembly comprising:
a channel device having a central channel portion extending between a first end and a second end and a pair of integrated end plates meeting the central channel portion at bendable edges at the first end and second end of the central channel portion, respectively, such that the integrated end plates are configured to pivot about the bendable edges, wherein each of the integrated end plates comprises a return flange; and
a platform device, comprising:
an aperture configured to receive the central channel portion of the channel device;
mating return flanges configured to engage the return flanges of the integrated end plates to secure the channel device to the platform device; and
a first platform portion and a second platform portion located on opposing sides of the channel device when the channel device is secured to the platform device.

2. The luminaire assembly of claim 1, wherein the return flange of each of the integrated end plates includes an end hook configured to catch the mating return flanges.

3. The luminaire assembly of claim 1, further comprising a channel cover configured to be coupled to the channel device and the platform device via one or more fasteners.

4. The luminaire assembly of claim 1, wherein at least one of the bendable edges is scored.

5. The luminaire assembly of claim 1, further comprising one or more flexible lenses configured to be received by the integrated end plates.

6. The luminaire assembly of claim 5, wherein the one or more flexible lenses are configured to be secured to the luminaire assembly via the return flange of the integrated end plates and a lip of a channel cover

7. The luminaire assembly of claim 1, wherein the channel device and/or the platform device are monolithic structures.

8. The luminaire assembly of claim 1, wherein the channel device and the platform device are substantially aluminum.

9. The luminaire assembly of claim 1, wherein the bendable edges are configured to enable the integrated end plates to pivot within a range of approximately 45 degrees.

10. The luminaire assembly of claim 1, further comprising a plurality of light sources mounted to the platform device.

11. The luminaire assembly of claim 1, further comprising a driver mounted to the central channel portion of the channel device.

12. A method for manufacturing a luminaire assembly, comprising:
inserting a central channel portion of a channel device into an aperture of a platform device, wherein the platform device comprises a first platform portion and a second platform portion located on opposing sides of the channel device when the central channel portion is inserted into the aperture; and
pivoting a pair of integrated end plates of the channel device about bendable edges of the channel device such that a return flange of each of the integrated end plates engages with mating return flanges of the platform device such that the channel device is secured to the platform device.

13. The method of manufacturing of claim 12, further comprising coupling a channel cover to the channel device and the platform device via one or more fasteners.

14. The method of manufacturing of claim 12, further comprising:
mounting a plurality of light sources to the platform device; and
mounting a driver to the central channel portion of the channel device.

15. The method of manufacturing of claim 12, further comprising securing one or more flexible lenses to the luminaire assembly via the return flange of the integrated end plates.
